(19) United States
(12) Patent Application Publication
(10) Pub. No.: US 2024/0146396 A1
(43) Pub. Date: May 2, 2024

(54) METHOD AND APPARATUS FOR COVERAGE EXTENSION AND WIRELESS COMMUNICATION

(71) Applicant: Lenovo (Beijing) Limited, Beijing (CN)

(72) Inventors: Lianhai Wu, Beijing (CN); Yibin Zhuo, Beijing (CN); Haiming Wang, Beijing (CN); Le Yan, Shanghai (CN); Mingzeng Dai, Shanghai (CN)

(73) Assignee: Lenovo (Beijing) Limited, Beijing (CN)

(21) Appl. No.: 18/277,270

(22) PCT Filed: Mar. 2, 2021
(86) PCT No.: PCT/CN2021/078668

§ 371 Date: Aug. 15, 2023

(51) Int. Cl. H04B 7/185

(52) U.S. Cl. CPC H04B 7/18504

(57) ABSTRACT

Embodiments of the present disclosure relate to methods and apparatuses for coverage extension and wireless communication. According to some embodiments of the disclosure, a method may include: receiving from a base station (BS) a message comprising an indication that a drone-based relay or vehicle-based relay is supported by the BS, wherein the mobile terminal is allowed to serve as a relay node between the BS and a user equipment (UE); and in response to receiving the indication indicating that a drone-based relay or vehicle-based relay is supported by the BS, performing a random access procedure with the BS. In addition, the mobile terminal may report the assistant information, e.g., the remaining power information, to the BS.

### TECHNICAL FIELD

Embodiments of the present disclosure generally relate to wireless communication technology, especially to coverage extension based on vehicle or drone-mounted relays in a wireless communication system and communications between an unmanned aerial vehicle (UAV) and a UAV controller over 3GPP connectivity.

### BACKGROUND

In a wireless communication system, a base station (BS) may be distributed over a geographic region and may serve a number of user equipment (UE) within a serving area, for example, a cell or a cell sector, via wireless communication links.

Installing additional base stations in certain environments may face typical deployment challenges and burdens. In some urban environments, one can expect the presence and availability of many vehicles, for example, buses, taxis, goods, food and delivery vehicles, etc., typically moving at low or pedestrian speed (or temporarily stationary). Some of such vehicles can follow a certain known or predictable itinerary or be situated in specific locations, for example, outside stadiums, and through or around areas where coverage and capacity need to be improved. The 3rd generation partnership project (3GPP) is interested in introducing these vehicles into the wireless network to improve and extend the coverage of a BS.

Moreover, in recent years, aerial vehicles, such as unmanned aerial vehicles (UAVs) (also known as “drones”) are becoming ever more popular. For example, more and more UAVs are commercially used in package delivery, search-and-rescue, monitoring of critical infrastructure, wildlife conservation, and as flying cameras and in surveillance. 3GPP has observed this trend and is interested in introducing UAVs or drones into the wireless network.

Therefore, the industry desires an improved technology to introduce vehicles or UAVs into the wireless network.

### SUMMARY

Some embodiments of the present disclosure provide a method performed by a mobile terminal. According to some embodiments of the present disclosure, the method may include: receiving from a base station (BS) a message comprising an indication that a drone-based relay or vehicle-based relay is supported by the BS, wherein the mobile terminal is suitable for serving as a relay node between the BS and a user equipment (UE); and in response to receiving the indication indicating that a drone-based relay or vehicle-based relay is supported by the BS, performing a random access procedure with the BS.

Some embodiments of the present disclosure provide a method performed by a mobile terminal controller. According to some embodiments of the present disclosure, the method may include: generating a control message associated with a mobile terminal, which is controllable by the mobile terminal controller, via a first layer over an access stratum (AS) layer of the mobile terminal controller, wherein the control message is to be transmitted to a base station (BS) that is accessible by the mobile terminal controller; and transmitting the control message to the BS.

Some embodiments of the present disclosure provide a method performed by a base station (BS). According to some embodiments of the present disclosure, the method may include: broadcasting a message comprising an indication that a drone-based relay or vehicle-based relay is supported by the BS; and in response to a successful random access procedure being performed between a mobile terminal and the BS, transmitting a configuration message to the mobile terminal, wherein the configuration message is for configuring the mobile terminal as a relay node between the BS and a user equipment (UE).

In some embodiments of the present disclosure, in the case that the indication indicates that a drone-based relay or vehicle-based relay is supported by the BS, the message further indicates a minimum height to be a relay node, a maximum height to be a relay node, a minimum time period to be a relay node, or any combination thereof.

In some embodiments of the present disclosure, the method may further include: in response to the successful random access procedure being performed between the mobile terminal and the BS, receiving one or more of the following from the mobile terminal: an indication of whether the mobile terminal acts as a drone-based relay or vehicle-based relay; a capability report indicating whether the mobile terminal acts as a drone-based relay or vehicle-based relay; and power information associated with the mobile terminal.

In some embodiments of the present disclosure, the configuration message indicates one or more of the following: an expected location of a relay node, an expected height of a relay node, or both; a maximum transmission power for reference signals of a relay node; and an expected coverage area of a relay node.

In some embodiments of the present disclosure, the method may further include: receiving an indication of whether the UE is within or outside the mobile terminal, wherein the UE is accessing the BS via the mobile terminal.

In some embodiments of the present disclosure, the method may further include: transmitting a condition for reporting power information associated with the mobile terminal. The method may further include: receiving the power information associated with the mobile terminal from the mobile terminal. The condition may include a time period that the remaining power of the mobile terminal can last is less than a threshold.

In some embodiments of the present disclosure, the method may further include: transmitting a polling indication requesting power information associated with the mobile terminal; and receiving the power information associated with the mobile terminal in response to receiving the polling indication.

In some embodiments of the present disclosure, the power information associated with the mobile terminal may indicate the remaining power of the mobile terminal, an estimated time period for providing services as a base station, or both. In some embodiments of the present disclosure, the power information associated with the mobile terminal may be carried in one of a physical layer, a medium access control (MAC) layer, a radio resource control (RRC) layer, and an adaptation layer.

Some embodiments of the present disclosure provide a method performed by a base station (BS). According to some embodiments of the present disclosure, the method may include: receiving, from a mobile terminal controller, a control message associated with a mobile terminal via a first layer over an access stratum (AS) layer of the BS, wherein the BS is accessible by the mobile terminal controller.

In some embodiments of the present disclosure, the mobile terminal may be an unmanned aerial vehicle (UAV). In some embodiments of the present disclosure, the first layer may be a layer above a packet data convergence protocol (PDCP) layer. In some embodiments of the present disclosure, the first layer may be an application layer. In some embodiments of the present disclosure, the control message may be carried in a signaling radio bearer associated of a radio resource control (RRC) layer. In some embodiments of the present disclosure, the control message may include an ID of the mobile terminal controller and an ID of the mobile terminal. The ID of the mobile terminal controller and the ID of the mobile terminal are unique at the BS.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

Embodiments of the present disclosure provide technical solutions for coverage extension and wireless communications and can facilitate and improve the implementation of various communication technologies, such as 5G NR.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present disclosure;

FIG. 2 illustrates an exemplary procedure for wireless communications in accordance with some embodiments of the present disclosure;

FIG. 3 illustrates an exemplary procedure for wireless communications in accordance with some embodiments of the present disclosure;

FIG. 4 illustrates an exemplary procedure for wireless communications in accordance with some embodiments of the present disclosure;

FIG. 5 illustrates an exemplary procedure for wireless communications in accordance with some embodiments of the present disclosure;

FIG. 5A illustrates an example block diagram of a protocol stack in accordance with some embodiments of the present disclosure; and

FIG. 6 illustrates a block diagram of an exemplary apparatus in accordance with some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under specific network architecture and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

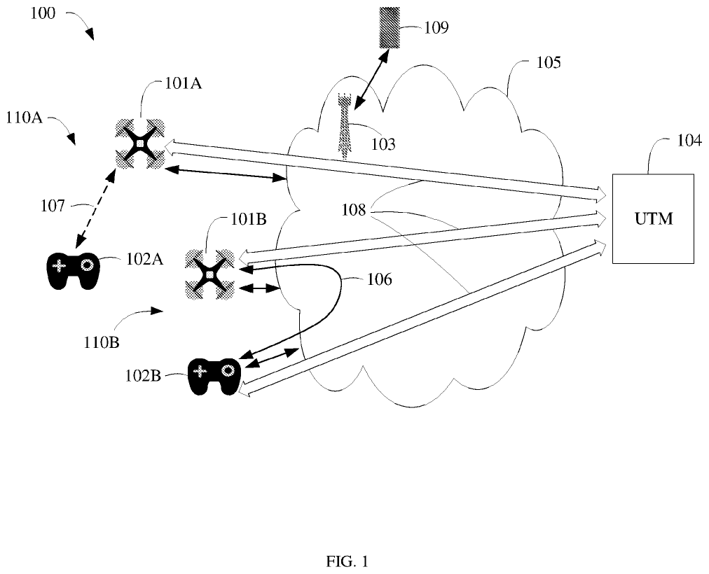

FIG. 1 illustrates a schematic diagram of a wireless communication system 100 in accordance with some embodiments of the present disclosure.

The wireless communication system 100 may include a wireless network (e.g., a 3GPP mobile network) 105. At least one BS may be deployed within wireless network 105 and may provide services to one or more UEs. For example, UE 109 may access BS 103. UE 109 and BS 103 may support communication based on, for example, 3G, Long-Term Evolution (LTE), LTE-Advanced (LTE-A), New Radio (NR), or other suitable protocol(s). For example, BS 103 may include an eNB or a gNB. UE 109 may include, for example, but is not limited to, a computing device, a wearable device, a mobile device, an IoT device, etc. In some embodiments of the present disclosure, UE 109 may be V2X UEs, for example, vehicles. Persons skilled in the art should understand that as technology develops and advances, the terminologies described in the present disclosure may change, but should not affect or limit the principles and spirit of the present disclosure.

The wireless communication system 100 may include an unmanned aerial system (UAS) (e.g., UAS 110A and UAS 110B), which may include an unmanned aerial vehicle (UAV) and a UAV controller. A UAV may be an aircraft without a human pilot onboard; or otherwise in some cases. A UAV can be controlled by a UAV controller and may have a range of autonomous flight capabilities. A UAV can be controlled by different UAV controllers; however, at any given time, a UAV is under the control of only one UAV controller. There are various mechanisms to ensure which UAV controller is active and controlling a specific UAV.

For example, in FIG. 1, UAS 110A may include UAV 101A and UAV controller 102A, and UAS 110B may include UAV 101B and UAV controller 102B. UAV 101A can be controlled by UAV controller 102A and UAV 101B can be controlled by UAV controller 102B.

A UAV (e.g., UAV 101A or UAV 101B) or UAV controller (e.g., UAV controller 102A or UAV controller 102B) may exchange application data traffic 108 with an unmanned aerial system traffic management (UTM) (e.g., UTM 104). UTM 104 may be used to provide a number of services to support a UAS and their operations including, for example, UAS identification and tracking, authorization, enforcement, regulation of UAS operations, and also to store the data required for a UAS(s) to operate. UTM 104 may allow authorized users (e.g., air traffic control, public safety agencies) to query the identity and metadata of a UAV (e.g., UAV 101A) and its UAV controller (e.g., UAV controller 102A).

The communication between the UAV and UAV controller may be via a command and control (C2) link, which is the user plane link to convey messages with information of command and control for a UAV operation between a UAV controller and a UAV. The communication requirements for a UAS may cover both the C2 communications and uplink and downlink data to/from the UAS components towards both the serving 3GPP network and network servers.

In some embodiments of the present disclosure, a UxNB (not shown in FIG. 1) may be carried in the air by a UAV (e.g., UAV 101A or UAV 101B) to extend the coverage or increase the capacity of a wireless network (e.g., wireless network 105). The UxNB can provide connectivity to UEs.

In some embodiments of the present disclosure, when using a 3GPP network as the transport network for supporting UAS services, the following C2 communications may be considered to provide UAS services by guaranteeing quality of service (QoS) for the C2 communication.
Direct C2 communication: the UAV controller and UAV may establish a direct C2 link to communicate with each other. In some cases, both the UAV controller and UAV may be registered with the 3GPP network (e.g., 5G network) using the radio resource configured and scheduled provided by the 3GPP network for direct C2 communication.
Network-Assisted C2 communication: the UAV controller and UAV may register and establish respective unicast C2 communication links with the 3GPP network (e.g., 5G network) and communicate with each other via the 3GPP network. Also, both the UAV controller and UAV may be registered with the 3GPP network via different radio access network (RAN) (e.g., next generation RAN (NG-RAN)) nodes. The 3GPP network may need to support mechanisms to handle the reliable routing of C2 communication.
UTM-Navigated C2 communication: the UAV may have been provided a pre-scheduled flight plan, for example, an array of 4D polygons, for autonomous flying. However, the UTM may still maintain a C2 communication link with the UAV in order to regularly monitor the flight status of the UAV, verify the flight status with up-to-date dynamic restrictions, provide route updates, and navigate the UAV whenever necessary.

In FIG. 1, UAV 101A and UAV 101B may be connected to wireless network 105, and may be connected over 3GPP connectivity. UAV controller 102A may not be connected to wireless network 105, and may control UAV 101A via a C2 interface 107 not in 3GPP scope. UAV controller 102B may be connected to wireless network 105, and may control UAV 101B via a C2 interface 106 over 3GPP connectivity. In some embodiments of the present disclosure, UAV controller 102B can control one or more UAV(s).

Although a specific number of UEs, BSs, UASs, UAVs, and UAV controllers are depicted in FIG. 1, it is contemplated that any number of UEs, BSs, UASs, UAVs, and UAV controllers may be included in the wireless communication system 100. Although one UAV and one UAV controller are depicted in a single UAS in FIG. 1, it is contemplated that any number of UAVs and UAV controllers may be included in a single UAS, and a UAV controller may control one or more UAV(s).

As mentioned above, installing additional base stations in certain environments may face typical deployment challenges and burdens. Vehicles and drones may offer a convenient and efficient place in which to install on-board base stations acting as relays to provide wireless network (e.g., 5G) coverage and connectivity to neighboring UEs outside the vehicles or drones. Moreover, vehicle or drone relays are also very suitable and optimal for connecting users or devices (e.g., UEs) inside the vehicles or drones, not only in urban areas, but also other environments, for example, for passengers in buses, cars, taxis, or trains. In other scenarios, for example, during an outdoor sport or pedestrian event, vehicles or drones equipped with relays can conveniently move along with users or devices that are outside the vehicles or drones and provide service to them.

In the above scenarios and the like, vehicle or drone relays can use wireless backhaul links toward the donor base stations connected to the core network. For example, referring to FIG. 1, in some embodiments of the present disclosure, UAV 101A may act as a drone-based relay and may use BS 103 to connect to the core network.

Embodiments of the present disclosure provide solutions to facilitate the usage of the vehicle or drone as a relay. For example, solutions for setting up the initial backhaul link are proposed.

Moreover, a vehicle-based relay can serve both a UE(s) inside the vehicle and a neighboring UE(s) in the vicinity of the vehicle. It would be helpful for handover if the network or relay can differentiate the inside-the-vehicle UE(s) from the neighboring UE(s). For example, when a vehicle-based relay moves from one cell to a neighboring cell, the network can perform a group-based handover. For instance, an inside-the-vehicle UE(s) connected to the relay can be handed over to the new cell along with the relay. In addition, when the network is aware of the inside-the-vehicle UE(s), a measurement report of such UE(s) can be saved. To solve the above issues, solutions for differentiating the inside-the-vehicle UE(s) from the neighboring UE(s) are proposed.

Furthermore, under certain scenarios, for example, when a drone-based relay or vehicle-based relay has a limited power, a donor base station may need to decide when to replace the relay. Solutions for solving this issue are proposed. For example, a mechanism for reporting the remaining power of a drone-based relay or vehicle-based relay is proposed.

In addition, as mentioned above, a UAV controller may control a UAV(s) via a C2 interface over 3GPP connectivity. This may have an impact on 3GPP networks. Embodiments of the present disclosure provide solutions for handling such possible impact.

More details on the embodiments of the present disclosure will be illustrated in the following text in combination with the appended drawings.

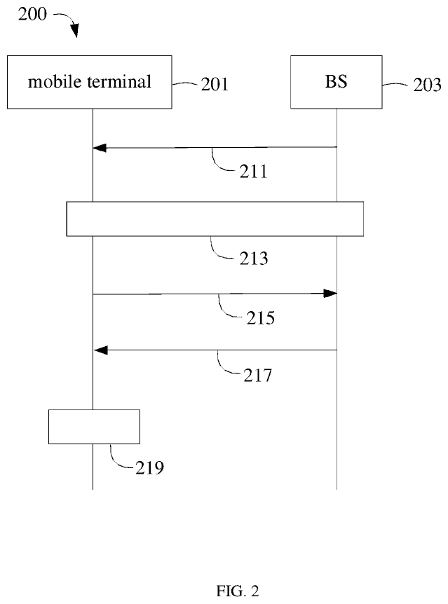

FIG. 2 illustrates an exemplary procedure 200 for wireless communications in accordance with some embodiments of the present disclosure. Details described in all of the foregoing embodiments of the present disclosure are applicable for the embodiments shown in FIG. 2.

Referring to FIG. 2, BS 203 may broadcast information within its coverage area. In operation 211, mobile terminal 201 may receive the broadcast information. Mobile terminal 201 may be suited for serving as a relay node between BS 203 and a UE(s). For example, BS 203 may function as BS 103 shown in FIG. 1, and mobile terminal 201 may function as UE 109, UAV 101A, or UAV 101B shown in FIG. 1.

In some embodiments of the present disclosure, the broadcast information may include an indication of whether a drone-based relay or vehicle-based relay is supported or not by BS 203. For example, a first value of the indication may indicate that a drone-based relay or vehicle-based relay is supported by BS 203, and a second value of the indication may indicate that a drone-based relay or vehicle-based relay is not supported by BS 203.

In some embodiments of the present disclosure, only when a BS supports a drone-based relay or vehicle-based relay may the BS broadcast an indication that a drone-based relay or vehicle-based relay is supported by the BS; and a BS may not broadcast such indication when the BS does not support a drone-based relay or vehicle-based relay. In some other embodiments of the present disclosure, only when a BS does not support a drone-based relay or vehicle-based relay may the BS broadcast an indication that a drone-based relay or vehicle-based relay is not supported by the BS; and a BS may not broadcast such indication when the BS supports a drone-based relay or vehicle-based relay.

In some embodiments of the present disclosure, in the case that the indication indicates that a drone-based relay or vehicle-based relay is supported by BS 203, the broadcast information may further indicate a minimum height to be a relay node, a maximum height to be a relay node, a minimum time period to be a relay node, or any combination thereof. For example, the broadcast information may indicate that only drones or vehicles with the power which can last for 2 hours can act as a relay node. The relay node can be an integrated access and backhaul (IAB) node.

In operation 213, in response to the indication indicating that a drone-based relay or vehicle-based relay is supported by BS 203, mobile terminal 201 may perform a random access procedure with BS 203. The random access procedure (RAP) may be performed according to one of the known RAPs in the art. Mobile terminal 201 may access BS 203 in response to a successful random access procedure.

In some embodiments of the present disclosure, the mobile terminal may be a drone or a vehicle, and may be hereinafter referred to as “drone-based node” “drone-mounted node,” “vehicle-mounted node,” or “vehicle-based node.” The drone-based node or vehicle-based node may include a mobile termination (MT), which performs the random access procedure with BS 203.

In operation 215, in response to mobile terminal 201 accessing BS 203, mobile terminal 201 (e.g., MT of mobile terminal 201) may transmit assistance information to BS 203.

For example, mobile terminal 201 may transmit one or more of the following to BS 203: an indication of whether mobile terminal 201 acts as a drone-based relay or vehicle-based relay; a capability report indicating whether mobile terminal 201 acts as a drone-based relay or vehicle-based relay; and power information associated with mobile terminal 201.

In some embodiments of the present disclosure, the power information may indicate the remaining power of mobile terminal 201, an estimated time period for mobile terminal 201 providing services as a base station, or both. In some embodiments of the present disclosure, the power information may be carried in one of a physical (PHY) layer, a medium access control (MAC) layer, a radio resource control (RRC) layer, and an adaptation layer.

In operation 217, in response to mobile terminal 201 accessing BS 203, BS 203 may configure mobile terminal 201 as a relay for transferring data from a UE(s). The configuration information may be transmitted via an RRC reconfiguration message.

For example, BS 203 may transmit one or more of the following to mobile terminal 201: an expected location of a relay node, an expected height of a relay node, or both; a maximum transmission power of a relay node for reference signals (e.g., synchronization signal block (SSB) and channel state information (CSI)-reference signal (RS) (CSI-RS)); and an expected coverage area of a relay node.

In operation 219, in response to receiving the RRC reconfiguration message, mobile terminal 201 may broadcast system information associated with the relay. At a certain time, a UE (not shown in FIG. 2) may access BS 203 via mobile terminal 201.

It should be appreciated by persons skilled in the art that the sequence of the operations in exemplary procedure 200 may be changed and some of the operations in exemplary procedure 200 may be eliminated or modified, without departing from the spirit and scope of the disclosure.

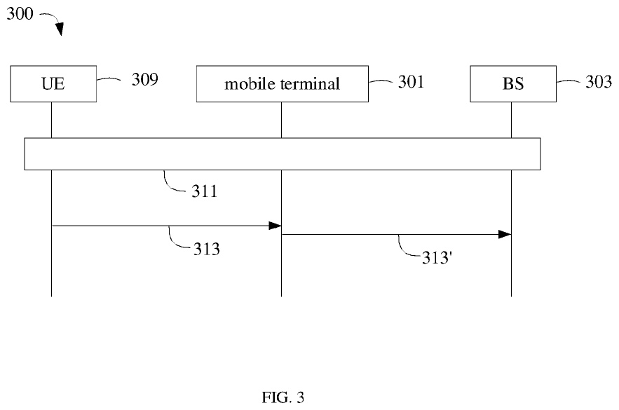

FIG. 3 illustrates an exemplary procedure 300 for wireless communications in accordance with some embodiments of the present disclosure. Details described in all of the foregoing embodiments of the present disclosure are applicable for the embodiments shown in FIG. 3.

Referring to FIG. 3, in operation 311, UE 309 is accessing BS 303 via mobile terminal 301. For example, BS 303 may function as BS 103 shown in FIG. 1 or BS 203 in FIG. 2, mobile terminal 301 may function as UE 109, UAV 101A, or UAV 101B shown in FIG. 1 or mobile terminal 201 in FIG. 2, and UE 309 may function as UE 109, UAV 101A, or UAV 101B shown in FIG. 1.

UE 309 may be inside of mobile terminal 301 or in the vicinity of mobile terminal 301. It would be beneficial to differentiate the two locations. UE 309 can identify this location information, i.e., whether it is inside or outside mobile terminal 301, according to various methods, including, for instance, manual selection or artificial intelligence (AI) based data mining. For example, a user of UE 309 may select, for example, via a user interface, whether UE 309 is inside or outside mobile terminal 301. In another example, the user of UE 309 may swipe a card for boarding a bus, and thus UE 309 may be aware that it is in the bus.

In some embodiments of the present disclosure, UE 309 may inform BS 203 whether UE 309 is inside or outside mobile terminal 301. For example, a first value of a location indication may indicate that UE 309 is inside mobile terminal 301, and a second value of the location indication may indicate that UE 309 is outside mobile terminal 301. For example, in operation 313 of FIG. 3, UE 309 may transmit a location indication of whether UE 309 is within or outside mobile terminal 301 to mobile terminal 301, which may transmit the location indication to BS 303 in operation 313′. BS 203 may determine whether UE 309 is inside or outside mobile terminal 301 based on the location indication.

In some embodiments of the present disclosure, only when UE 309 is inside mobile terminal 301 may UE 309 transmit a location indication indicating that UE 309 is within mobile terminal 301. BS 203 may presume that UE 309 is outside mobile terminal 301 without receiving such indication. In some embodiments of the present disclosure, only when UE 309 is outside mobile terminal 301 may UE 309 transmit an indication indicating that UE 309 is outside mobile terminal 301. BS 203 may presume that UE 309 is inside mobile terminal 301 without receiving such indication.

An application layer of UE 309 may obtain the location information associated with UE 309. In some embodiments of the present disclosure, the application layer of UE 309 may transmit a location indication to the application layer of BS 303, which may inform an access stratum (AS) layer of BS 303 whether UE 309 is inside or outside mobile terminal 301. In some embodiments of the present disclosure, the application layer of UE 309 may inform an AS layer of UE 309 whether UE 309 is inside or outside mobile terminal 301. The AS layer of UE 309 may transmit a location indication to a corresponding AS layer of BS 303. The AS layer of a UE or a BS may include a physical (PHY) layer, a medium access control (MAC) layer, a radio link control (RLC) layer, a packet data convergence protocol (PDCP) layer, and a radio resource control (RRC) layer.

It should be appreciated by persons skilled in the art that the sequence of the operations in exemplary procedure 300 may be changed and some of the operations in exemplary procedure 300 may be eliminated or modified, without departing from the spirit and scope of the disclosure.

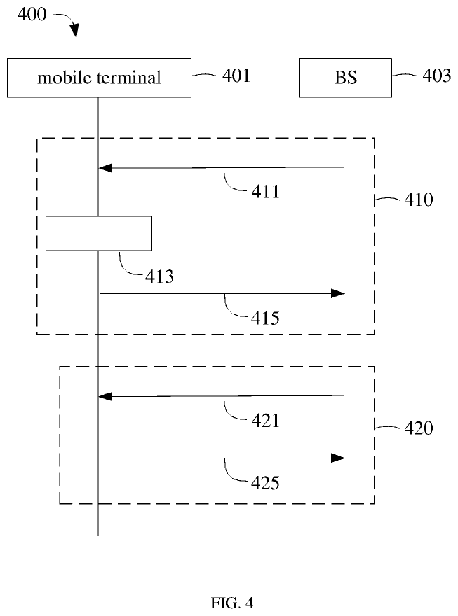

FIG. 4 illustrates an exemplary procedure 400 for wireless communications in accordance with some embodiments of the present disclosure. Details described in all of the foregoing embodiments of the present disclosure are applicable for the embodiments shown in FIG. 4.

Referring to FIG. 4, mobile terminal 401 is accessing BS 403 and may function as a relay node between BS 403 and a UE (not shown in FIG. 4). For example, BS 403 may function as BS 103 in FIG. 1, BS 203 in FIG. 2, or BS 303 in FIG. 3, and mobile terminal 401 may function as UE 109, UAV 101A, or UAV 101B in FIG. 1, mobile terminal 201 in FIG. 2, or mobile terminal 201 in FIG. 3.

Various mechanisms for reporting the remaining power of a mobile terminal may be employed.

In some embodiments of the present disclosure, to report the remaining power of mobile terminal 401, procedure 410 may be applied (denoted by dotted block as an option). Procedure 410 may include operations 411-415.

In operation 411, BS 403 may transmit a condition for reporting power information to mobile terminal 401. In some examples, the condition may include a time period that the remaining power of a mobile terminal can last is less than a threshold. For example, the condition can be the period of the remaining power of a mobile terminal is less than 20 minutes.

In operation 413, mobile terminal 401 may determine whether the configured condition is met or not. In response to the condition being met, mobile terminal 401 may transmit power information associated with mobile terminal 401 to BS 403 in operation 415.

In some embodiments of the present disclosure, the power information associated with mobile terminal 401 may indicate the remaining power of mobile terminal 401, an estimated time period for mobile terminal 401 providing services as a base station, or both. In some embodiments of the present disclosure, the power information associated with mobile terminal 401 may be carried in one of a PHY, a MAC layer, an RRC layer, and an adaptation layer.

In some embodiments of the present disclosure, to report the remaining power of mobile terminal 401, procedure 420 may be applied (denoted by dotted block as an option). Procedure 420 may include operations 421 and 425.

In operation 421, BS 403 may transmit a polling indication to mobile terminal 401. The polling indication may request power information associated with the mobile terminal. In response to receiving the polling indication, mobile terminal 401 may report power information associated with mobile terminal 401 to BS 403 in operation 425. The power information associated with a mobile terminal as described above can also apply here.

In some embodiments of the present disclosure, various mechanisms for reporting the remaining power of a mobile terminal may be applied alone or in combination. For example, procedures 410 and 420 may be applied in combination to report the power information of a mobile terminal.

It should be appreciated by persons skilled in the art that the sequence of the operations in exemplary procedure 400 may be changed and some of the operations in exemplary procedure 400 may be eliminated or modified, without departing from the spirit and scope of the disclosure.

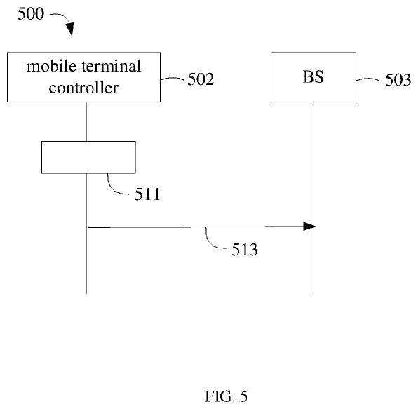

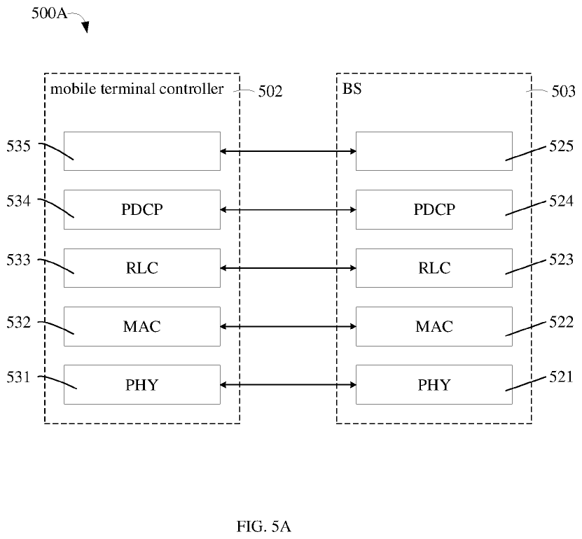

FIG. 5 illustrates an exemplary procedure 500 for wireless communications in accordance with some embodiments of the present disclosure. Details described in all of the foregoing embodiments of the present disclosure are applicable for the embodiments shown in FIG. 5.

Referring to FIG. 5, mobile terminal controller 502 is accessing BS 503. Mobile terminal controller 502 may control at least one mobile terminal (not shown in FIG. 5), which may be a UAV. For example, BS 503 may function as BS 103 in FIG. 1, BS 203 in FIG. 2, BS 303 in FIG. 3, or BS 403 in FIG. 4, and mobile terminal controller 502 may function as UAV controller 102A or UAV controller 102B in FIG. 1.

Some of all of the at least one mobile terminal under the control of mobile terminal controller 502 may access the network via BS 503 or a different BS (not shown in FIG. 5). Mobile terminal controller 502 may control a mobile terminal which also connects to the network via the C2 interface over 3GPP connectivity.

For example, in some embodiments of the present disclosure, mobile terminal controller 502 may generate a control message associated with a mobile terminal (not shown in FIG. 5) in operation 511. The mobile terminal is accessing the network and is controllable by mobile terminal controller 502. In some embodiments of the present disclosure, the control message may include an ID of mobile terminal controller 502 and an ID of the mobile terminal, which may be unique at BS 503.

In operation 513, mobile terminal controller 502 may transmit the control message to BS 503. BS 503 may transfer the control message to the corresponding mobile terminal. For example, after BS 503 receives the control message, BS 503 may deliver it to a core network component, for example, access management function (AMF) or user plane function (UPF), which may transfer the message to a BS serving the mobile terminal.

In some embodiments of the present disclosure, the control message may be generated at a layer over an AS layer of mobile terminal controller 502.

In some embodiments of the present disclosure, the control message may be generated at an upper layer, for example, the application layer, of mobile terminal controller 502. The application layer of mobile terminal controller 502 may deliver the control message to lower layers for transmission.

In some embodiments of the present disclosure, a new layer may be introduced for generating the control message. For example, FIG. 5A illustrates an example block diagram of a protocol stack 500A for mobile terminal controller 502 and BS 503 in accordance with some embodiments of the present disclosure.

Referring to FIG. 5A, the protocol stack of BS 503 may include AS layers including a PHY layer 521, a MAC layer 522, an RLC layer 523, and a PDCP layer 524 and a layer 525 above the AS layers (e.g., above PDCP layer 524). The protocol stack of mobile terminal controller 502 may include AS layers including a PHY layer 531, a MAC layer 532, an RLC layer 533, and a PDCP layer 534 and a layer 535 above the AS layers (e.g., above PDCP layer 534). Other known protocol layers (e.g., application layer) may be included in the protocol stacks of BS 503 and mobile terminal controller 502 and are not shown in FIG. 5A.

In the example of FIG. 5A, layer 535 at mobile terminal controller 502 may be used to generate the control message associated with a mobile terminal. Accordingly, BS 503 may receive the control message via layer 525.

In some embodiments of the present disclosure, the control message may be carried in a signaling radio bearer (SRB) of a radio resource control (RRC) layer. For example, the control message may be mapped to an SRB in the RRC layer of mobile terminal controller 502.

It should be appreciated by persons skilled in the art that the sequence of the operations in exemplary procedure 500 may be changed and some of the operations in exemplary procedure 500 may be eliminated or modified, without departing from the spirit and scope of the disclosure.

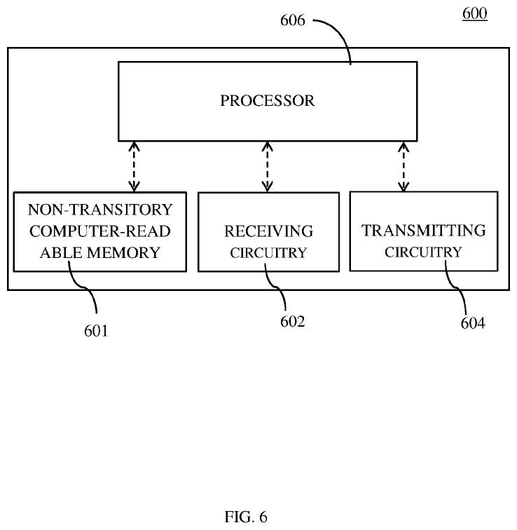

FIG. 6 illustrates a block diagram of an exemplary apparatus 600 according to some embodiments of the present disclosure.

As shown in FIG. 6, the apparatus 600 may include at least one non-transitory computer-readable medium 601, at least one receiving circuitry 602, at least one transmitting circuitry 604, and at least one processor 606 coupled to the non-transitory computer-readable medium 601, the receiving circuitry 602 and the transmitting circuitry 604. The apparatus 600 may be a base station side apparatus (e.g., a BS) or a communication device (e.g., a UE, a mobile terminal, or a mobile terminal controller).

Although in this figure, elements such as the at least one processor 606, transmitting circuitry 604, and receiving circuitry 602 are described in the singular, the plural is contemplated unless a limitation to the singular is explicitly stated. In some embodiments of the present application, the receiving circuitry 602 and the transmitting circuitry 604 are combined into a single device, such as a transceiver. In certain embodiments of the present application, the apparatus 600 may further include an input device, a memory, and/or other components.

In some embodiments of the present disclosure, the non-transitory computer-readable medium 601 may have stored thereon computer-executable instructions to cause a processor to implement the method with respect to the UEs as described above. For example, the computer-executable instructions, when executed, cause the processor 606 interacting with receiving circuitry 602 and transmitting circuitry 604, so as to perform the operations with respect to the UEs described in FIGS. 1 and 3.

In some embodiments of the present disclosure, the non-transitory computer-readable medium 601 may have stored thereon computer-executable instructions to cause a processor to implement the method with respect to the mobile terminals as described above. For example, the computer-executable instructions, when executed, cause the processor 606 interacting with receiving circuitry 602 and transmitting circuitry 604, so as to perform the operations with respect to the mobile terminal described in FIGS. 1-5.

In some embodiments of the present disclosure, the non-transitory computer-readable medium 601 may have stored thereon computer-executable instructions to cause a processor to implement the method with respect to the mobile terminal controllers as described above. For example, the computer-executable instructions, when executed, cause the processor 606 interacting with receiving circuitry 602 and transmitting circuitry 604, so as to perform the operations with respect to the mobile terminal controllers described in FIGS. 1 and 5.

In some embodiments of the present disclosure, the non-transitory computer-readable medium 601 may have stored thereon computer-executable instructions to cause a processor to implement the method with respect to the BSs as described above. For example, the computer-executable instructions, when executed, cause the processor 606 interacting with receiving circuitry 602 and transmitting circuitry 604, so as to perform the operations with respect to the BSs or cells described in FIGS. 1-5.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present application, but is not used to limit the substance of the present application.

1. A method performed by a mobile terminal, comprising:
receiving, from a base station (BS), a message comprising an indication that a drone-based relay or vehicle-based relay is supported by the BS, the mobile terminal serving as a relay node between the BS and a user equipment (UE); and
performing, in response to receiving the indication that the drone-based relay or vehicle-based relay is supported by the BS, a random access procedure with the BS.

2. The method of claim 1, wherein the mobile terminal is a drone or a vehicle.

3. The method of claim 1, wherein in a case that the received indication indicates that the drone-based relay or vehicle-based relay is supported by the BS, the message further indicates at least one of a minimum height to be the relay node, a maximum height to be the relay node, and a minimum time period to be the relay node.

4. The method of claim 1, further comprising, in response to the mobile terminal accessing the BS, transmitting to the BS one or more of:
an indication of whether the mobile terminal acts as the drone-based relay or vehicle-based relay;
a capability report indicating whether the mobile terminal acts as the drone-based relay or vehicle-based relay; and
power information associated with the mobile terminal.

5. The method of claim 1, further comprising, in response to the mobile terminal accessing the BS, receiving from the BS one or more of:
at least one of an expected location of the relay node and an expected height of the relay node;
a maximum transmission power of the relay node for reference signals; and
an expected coverage area of the relay node.

6. (canceled)

7. (canceled)

8. (canceled)

9. (canceled)

10. (canceled)

11. (canceled)

12. A method performed by a mobile terminal controller, comprising:
generating a control message associated with a mobile terminal that is an unmanned aerial vehicle (UAV) and is controllable by the mobile terminal controller via a first layer over an access stratum (AS) layer of the mobile terminal controller; and
transmitting the control message to a base station (BS) that is accessible by the mobile terminal controller.

13. The method of claim 12, wherein the first layer is a layer above a packet data convergence protocol (PDCP) layer, or wherein the first layer is an application layer.

14. The method of claim 12, wherein the control message comprises an ID of the mobile terminal controller and an ID of the mobile terminal, and wherein the ID of the mobile terminal controller and the ID of the mobile terminal are unique at the BS.

15. A mobile terminal for wireless communication, comprising:
at least one memory; and
at least one processor coupled with the at least one memory and configured to cause the mobile terminal to:
receive, from a base station (BS), a message comprising an indication that a drone-based relay or vehicle-based relay is supported by the BS, the mobile terminal serving as a relay node between the BS and a user equipment (UE); and
perform, in response to receiving the indication that the drone-based relay or vehicle-based relay is supported by the BS, a random access procedure with the BS.

16. The mobile terminal of claim 15, wherein the mobile terminal is a drone or a vehicle.

17. The mobile terminal of claim 15, wherein in a case that the received indication indicates that the drone-based relay or vehicle-based relay is supported by the BS, the message further indicates at least one of a minimum height to be the relay node, a maximum height to be the relay node, and a minimum time period to be the relay node.

18. The mobile terminal of claim 15, wherein the at least one processor is configured to cause the mobile terminal to, in response to the mobile terminal accessing the BS, transmit to the BS one or more of:
an indication of whether the mobile terminal acts as the drone-based relay or vehicle-based relay;
a capability report indicating whether the mobile terminal acts as the drone-based relay or vehicle-based relay; and
power information associated with the mobile terminal.

19. The mobile terminal of claim 15, wherein the at least one processor is configured to cause the mobile terminal to, in response to the mobile terminal accessing the BS, receive from the BS one or more of:
at least one of an expected location of the relay node and an expected height of the relay node;
a maximum transmission power of the relay node for reference signals; and
an expected coverage area of the relay node.

20. The mobile terminal of claim 15, wherein the at least one processor is configured to cause the mobile terminal to:
receive a condition for reporting power information associated with the mobile terminal.

21. The mobile terminal of claim 20, wherein the at least one processor is configured to cause the mobile terminal to:
report the power information associated with the mobile terminal to the BS in response to the condition being met.

22. The mobile terminal of claim 20, wherein the condition comprises a time period that a remaining power of the mobile terminal can last is less than a threshold.

23. The mobile terminal of claim 15, wherein the at least one processor is configured to cause the mobile terminal to:
receive a polling indication requesting power information associated with the mobile terminal from the BS; and
report the power information associated with the mobile terminal to the BS in response to receiving the polling indication.

24. The mobile terminal of claim 23, wherein the power information associated with the mobile terminal indicates at least one of a remaining power of the mobile terminal and an estimated time period for providing services as a base station.

25. The mobile terminal of claim 15, wherein the message received from the BS comprises a further indication that the drone-based or vehicle-based relay is not supported by the BS.

26. A base station for wireless communication, comprising:
at least one memory; and
at least one processor coupled with the at least one memory and configured to cause the base station to:
broadcast a message comprising an indication that a drone-based relay or vehicle-based relay is supported by the base station; and
transmit, in response to a successful random access procedure being performed between a mobile terminal and the base station, a configuration message to the mobile terminal that configures configuring the mobile terminal as a relay node between the base station and a user equipment.
